(19) United States
(12) Patent Application Publication
(10) Pub. No.: US 2009/0123958 A1
(43) Pub. Date: May 14, 2009

(54) Laboratory Devices, Methods and Systems Employing Acoustic Ejection Devices

(75) Inventor: Amiram CARMON, Jerusalem (IL)

Correspondence Address: THE NATH LAW GROUP, 112 South West Street, Alexandria, VA, 22314, US

(73) Assignee: INKJET TECHNOLOGY LTD., Jerusalem (IL)

(21) Appl. No.: 11/667,186

(22) PCT Filed: Nov. 8, 2005
(86) PCT No.: PCT/IL05/01169

§ 371 Date: May 7, 2007

(30) Foreign Application Priority Data
Nov. 8, 2004 (IL) 165092
Feb. 22, 2005 (IL) 167048
Feb. 22, 2005 (IL) 167050

(51) Int. Cl. C12Q 1/02; C12M 1/34

(52) U.S. Cl. 435/29; 435/288.3

(57) ABSTRACT

A method for performing chemically analyzing samples (e.g. bodily fluids) dispensed with an acoustic ejection device is disclosed. A method preparing a sample for analysis by centrifuging the sample in a sample collection device in fluid communication with an acoustic ejection device is disclosed. A method for laboratory analysis of biological and/or other fluids, wherein a single electromechanical pump including an acoustic ejection device draws and ejects fluids is disclosed. A device for dispensing a fluid, where a ratio between a reservoir of the device and an ejection chamber is between 50 and 4,000 is disclosed. A system including a plurality of acoustic ejection devices in an environmentally enclosed housing is disclosed.

### FIELD OF THE INVENTION

The present invention relates to methods, systems, and devices for mixing and analyzing liquids, such as reagents and samples in a laboratory or clinical environment.

### BACKGROUND OF THE INVENTION

It is standard medical practice to obtain biological samples (blood and other samples) from patients and other subjects in order to carry out a wide battery of biochemical and immunochemical determinations designed to diagnose a disease state, present or potential, monitor subjects for improvement or deterioration of health, and to obtain other information. For example, tests may be chemical, in which case organic or inorganic chemicals may be tested, or immunological, in which the presence in the blood of antigens and antibodies is tested.

In most clinical laboratories, automated instruments are capable of performing several tests on the biological samples. The procedure involves distributing small amounts of the biological sample into different analytical cells, such as glass or plastic cuvettes, and adding chemical or biological reagents from small containers. After a reaction occurs between the samples and reagents, the result of the reaction is usually determined by sensitive optical detection, electric sensing, or spectrometry.

As the number of tests performed in countries with modern medical care is cumulatively very large, huge quantities of reagents are consumed annually, and they constitute a major part of the cost of in vitro diagnostic procedures.

Another problem of the conventional clinical laboratory equipment is its size. The instruments take up a large space in the lab and require a complicated infrastructure with solid and liquid waste disposal, purified water, and other systems. In addition, almost all the systems have complex mechanical systems for dispensing. It is therefore useful mostly for hospital laboratories or large service laboratories and not for small medical practices. In these locations, sometimes far removed from the central clinical laboratory, many tests cannot be carried out due to the cost of reagents and/or instruments, and samples are transported to regional or reference laboratories, further contributing to the cost and delay of testing biological samples.

There is an ongoing need for systems, methods, and device useful for analyzing sample fluids (e.g. biological fluids) while consuming a minimal quantity of reagent.

The following patents and published patent document, each of which are incorporated herein by reference, provide potentially relevant background art:
U.S. Pat. No. 5,449,754, U.S. Pat. No. 4,877,745, U.S. Pat. No. 5,658,802, U.S. Pat. No. 6,375,627, U.S. Pat. No. 6,607,362, U.S. Pat. No. 4,877,745, U.S. Pat. No. 5,658,802, U.S. Pat. No. 6,607,362, U.S. Pat. No. 6,375,627, U.S. Pat. No. 6,607,362, and U.S. Pat. No. 5,474,796.

The following devices include ink jet technology.
1) Fuji electric systems—MICROJET RECORDER E TYPE: PHE-2 TN2PBEVb-E
2)Dimatix DMP-2800 & DMC-10000 Series or Dimatix SX-128

Descriptions of the aforementioned devices provide potentially relevant background material.

### SUMMARY OF THE INVENTION

The aforementioned needs are satisfied by several aspects of the present invention.

It is now disclosed for the first time a method of the current invention which comprises the steps of (a) dispensing with a first acoustic ejection device a reagent liquid to a defined location, said reagent associated with a specific detectable compound; b) after said dispensing of said reagent, dispensing with a second acoustic ejection device a sample liquid to said defined location; c) determining at least one of a presence and a quantity of said specific compound in said sample by analyzing said combined ejected reagent and sample at said defined location.

According to some embodiments, at least one of the local temperature and the local humidity at the defined location is controlled (e.g. within a housing containing acoustic ejection devices, or at a specific defined location such as a defined location on a reaction plate). In one non-limiting example, the temperature is controlled within 2 degrees Celsius, or preferably within 1 degree Celsius. In one non-limiting example, “controlling” a local humidity refers to controlling the humidity within a 10%, or preferably within a 5% tolerance. In a specific example, the controlling of the local humidity entails preventing the local humidity for dropping below a certain threshold (e.g. 90% humidity, or 95% humidity).

In some embodiments, the specific compound is a biological compound, though this is not a limitation of the present invention. Exemplary such specific compounds include but are not limited to carbohydrates, nucleic acids, proteins, and lipids (e.g. cholesterol or any other lipid).

According to some embodiments, said sample liquid includes at least one of a bodily fluid (e.g. blood) and a biological compound.

Optionally, the sample is preprocessed before being dispensed. In one example, the sample is subjected to a separations process (a process where two or more dissolved or suspended compounded are separated from each other, e.g. centrifugation or electrophoresis or any other separations process) before said dispensing with said second acoustic ejection device.

According to some embodiments, said separations process includes a centrifugation process.

According to some embodiments, said sample is centrifuged in a sample collection device.

According to some embodiments, said sample collection device is mechanically attached to acoustic ejection device.

According to some embodiments, said sample collection device is engaged to said first acoustic ejection device after said centrifuging.

According to some embodiments, said determining includes assessing a quantity for a presence of a tagged antibody. One example of assessing a “quantity” of a compound (e.g. a tagged antibody) is assessing a concentration of the compound. A “bound tagged antibody” and the quantity of the antibody may indicate the presence or quantity of the antigen in the sample.

According to some embodiments, said sample and said reagent are dispensed to a plurality of distinct said defined locations, and a local area of said defined locations is substantially flat area on a plate.

According to some embodiments, said sample and said reagent are dispensed onto a flat plate.

According to some embodiments, for a given reaction site, a quantity of dispensed reagent exceeds a quantity of dispensed sample.

According to some embodiments, only a minute quantity of said reagent is dispensed to a said defined location.

According to some embodiments, for a given said defined location, a ratio between a quantity of said ejected reagent and a quantity of said sample exceeds 10. In some embodiments, this ratio exceeds 15 or 20.

Thus, in some embodiments, quantities of sample less than 1 microliter are dispensed, and the total amount of sample for a battery of tests (e.g. up to 100 tests) needed is less than 100 microliters. Small quantities of sample (e.g. biological samples such as bodily fluids) may be obtained by capillary prick or by sampling of interstitial fluid. According to some embodiments, the present invention obviates the need to draw larger quantities of blood, since the amount of sample necessary for testing is miniscule. This is especially important for neonates, trauma victims, and critical care patients (among others), for whom obtaining sufficient sample is difficult.

According to some embodiments, for a given said defined location, a ratio between a quantity of said ejected reagent and a quantity of said sample is substantially equal to a pre-determined reagent-sample proportion.

According to some embodiments, a given said sample and said reagent are dispensed to a plurality of distinct said defined locations, said determining is performed for each respective said locations, and a statistical function is derived for said plurality of said locations.

According to some embodiments, said dispensing to said plurality of defined locations, and said determining at said plurality of said defined locations is carried out substantially simultaneously.

According to some embodiments, for a given said sample, the method is repeated a plurality of times using a plurality of distinct reagents.

According to some embodiments, for a given said sample, the method is repeated a plurality of times using a plurality of distinct reagents for the detection of a plurality of compounds in the said sample.

According to some embodiments, said reagent and said sample are thoroughly mixed at said defined location.

According to some embodiments, upon completion of the required determinations of a supply of said sample, said second device is disposed of.

A “surface having hydrobic properties” is defined as a surface operative to substantially confine a given quantity of a liquid (e.g. a water based or aqueous liquid) (in some examples, between 1-100 nanoliters, or even up to 5 microliters) to a specific location. In some embodiments, this liquid is dispensed onto the coating by ejecting a plurality of “micro droplets” each having a size on the order of magnitude of about 10 pico-liters. In some embodiments, the material is confined to the specific location within a given tolerance, for example 1 millimeter.

According to some embodiments, said sample and reagent are dispensed onto a plate having a hydrophobic coating.

According to some embodiments, said reaction plate has a hydrophobic and a hydrophilic coating in a pattern that substantially confines the location of the reaction.

According to some embodiments, air bubbles are substantially removed from said sample before said dispensing of said sample.

It is now disclosed for the first time a method of preparing a sample for analysis, the method comprising: a) receiving a sample in a sample collection device; b) mechanically attaching said sample collection device to an acoustic ejection device; c) centrifuging said attached sample collection device and acoustic ejection device to subject said sample to a separations process. A capillary tube is an example of a “sample collection device.”

It is now disclosed for the first time a method of preparing a sample for analysis, the method comprising: a) receiving a sample in a sample collection device that is integrally formed with a conduit of a acoustic ejection device; and b) centrifuging said sample collection device and said acoustic ejection device to subject said sample to a separations process.

It is now disclosed for the first time a method of mixing comprising: a) ejecting with a first acoustic ejection device a first liquid to a defined location; and b) after said ejecting of said first liquid, ejecting with a second acoustic device a second liquid to said defined location such that said second liquid thoroughly mixes with said first liquids at said defined location.

It is now disclosed for the first time a method of sample analysis comprising: a) dispensing with a first acoustic ejection device a reagent liquid to a defined location, said reagent associated with a specific detectable compound; b) after said dispensing of said reagent, dispensing with a second acoustic ejection device a sample liquid to said defined location; c) allowing said ejected sample and said ejected reagent to chemically react at said location.

It is now disclosed for the first time a method of aspirating a fluid into acoustic ejection device having a piezoelectric element configured to send an acoustic signal through an ejection chamber, the method comprising: engaging an outlet (e.g. such as a nozzle) of the acoustic ejection device to a fluid; and aspirating said fluid (e.g. by actuating a piezoelectric element) into a reservoir of said acoustic ejection device through said outlet.

An example of “engaging to the fluid” is inserting the outlet into the fluid, so that fluid can be aspirated. In some embodiments, actuating the piezoelectric elements draws the fluid into a reservoir (e.g. whose volume is at least an order of magnitude larger than a volume of an ejection chamber of the acoustic device) of said acoustic ejection device through said outlet. In some embodiments, fluid is aspirated through the ejection chamber and the inlet conduit.

According to some embodiments, the previous method fider comprises c) ejecting said fluid from said cavity through said outlet.

According to some embodiments, said fluid is a bodily fluid.

It is now disclosed for the first time a method for laboratory analysis of biological and other fluids, wherein a single electromechanical pump containing an acoustic ejection device draws and ejects fluids as a two-way pump.

According to some embodiments, said acoustic ejection device includes an ejection chamber that receives fluid from a fluid reservoir, and said dispensing of said fluid is operative to eject at least 1% of the stored fluid stored in said fluid reservoir.

According to some embodiments, said acoustic ejection device includes an ejection chamber that receives fluid from a capillary tube.

According to some embodiments, capillary forces are employed to draw fluid into said capillary tube.

It is now disclosed for the first time an acoustic ejection device for dispensing a fluid, the device comprising: a) a reservoir for holding the fluid, b) an ejection chamber for holding a nano quantity of the fluid and for expelling the fluid; c) an inlet conduit for delivering the fluid from said reservoir to said ejection chamber; d) an outlet for transporting said ejected fluid from said ejection chamber to dispense the fluid from the device; and e) a piezoelectric element configured to send an acoustic signal through said chamber, said acoustic signal being operative to draw the fluid located in said reservoir through said conduit, chamber and outlet to eject the fluid from the device, wherein a volume of said inlet conduit and said outlet is substantially smaller than a volume of said ejection chamber, and a ratio between a volume of said reservoir and said ejection chamber is between 50 and 4,000.

According to some embodiments, said reservoir is integrally formed with said conduit.

According to some embodiments, at least one of said chamber, said outlet and said reservoir is embedded in a wafer (e.g. constructed of an intert material such as silicon, glass).

According to some embodiments, the device further comprises: f) a covering layer for forming a seal with said wafer to close at least one said embedded chamber, outlet and reservoir.

According to some embodiments, said reservoir is at least partially open to the ambient environment.

According to some embodiments, said reservoir is substantially tubular.

It is now disclosed for the first time a system comprising: a) a housing; b) a first acoustic ejection device for dispensing a reagent; c) an acoustic ejection device for dispensing a sample; and d) an environmental control device associated with said housing for controlling at least one of temperature and humidity.

According to some embodiments, the system further comprises: e) a substantially flat late for supporting said dispensed reagent and sample.

It is now disclosed for the first time a system comprising: a) a first acoustic ejection device for dispensing a reagent; b) the acoustic ejection device for dispensing a sample; and c) a substantially flat plate for supporting said dispensed reagent and sample.

It is now disclosed for the first time a system for analysis comprising: a) a housing; b) a first acoustic ejection device for ejecting a reagent liquid from a first fluid source onto a surface; c) a second acoustic ejection device for ejecting a sample liquid from a second fluid source onto said surface; and d) an environmental control device associated with said housing for controlling at least one of temperature and humidity.

According to some embodiments, the system further comprises: e) a substantially flat plate for supporting said dispensed reagent and sample.

According to some embodiments, the system may alternately further comprise: e) a detection device for monitoring at least one of chemical interactions between said reagent and said sample, a chemical reaction between said reagent and said sample, a quantity of a compound, the presence or absence of a compound, and a characteristic of a compound.

According to some embodiments, the system may alternately further comprise: e) a coated plate for providing said surface onto which said reagent and sample liquids are ejected, said surface of said coated plate being coated with hydrophobic coating.

According to some embodiments, said second acoustic ejection device is connected to a capillary sample collection tube, and they are capable of being centrifuged together.

These and further embodiments will be apparent from the detailed description and examples that follow.

### BRIEF DESCRIPTION OF THE DRAWINGS

The invention is herein described, by way of example only, with reference to the accompanying drawings, wherein:

FIGS. 1, 3, 4 and 6 provide images of an acoustic ejection exemplary device for ejecting sample fluid according to some embodiments of the present invention.

FIG. 2 provides an image of an exemplary device for ejecting reagent fluid according to some embodiments of the present invention.

FIG. 5 is an in-process microphotograph demonstrating the mixing action created by ejecting dark fluid into a droplet of clear fluid.

FIG. 7 depicts an exemplary reaction plate having hydrophobic properties (e.g. the plate has hydrophilic coating and hydrophobic lines).

FIGS. 8-9 provides microscopy images of a sample mixing with rejection.

FIG. 10 is a schematic diagram related to certain embodiments of the present invention.

While the invention has been described with respect to a limited number of embodiments, it will be appreciated that many variations, modifications and other applications of the invention may be made.

### DETAILED DESCRIPTION OF THE INVENTION

The present inventors are disclosing a method and device for carrying out a multiplicity of biochemical testing and immunoassays simultaneously and repetitively based on inert micro-machined silicon and glass dispensing and aspirating devices operated by electrical pulses which drive piezo-electrical elements. The contraction of the piezo elements results in acoustic shock waves, which forces reagent droplets from a small nozzle connected to the cavity of the pump. A similar mechanism ejects the sample. In some embodiments, the device used for ejecting the sample is also used to aspirate the sample prior to ejection. Both sample and reagents are ejected onto the same location of a reaction plate, which constitutes the testing bed, and which is situated within a controlled environment chamber. The reaction plate can position accurately under the ejecting nozzles in the X, Y, and Z axes. The surface properties of the reaction plate and the controlled environment hold the liquids in a confined space. The mixing of the sample and reagent fluids is achieved by the high speed and high rate of fluid ejections without the need for a separate mixing device. The testing of the reaction results is done by conventional laboratory determination using devices based on optical, spectrophotometric, and electrical principles. The design allows the construction of a device belonging to the category of clinical laboratory multi-channel analyzer (MCA) with the characteristics of very small size, very few moving and mechanical parts, utilization of minute amounts of reagents and sample fluid, and elimination of washing and drying of the components of the reaction sequence.

According to some embodiments, the present invention relates to the methods and systems for reducing consumptions of quantities of biological samples and reagents used in semi-automated or fully automated medical and laboratory equipment for clinical biochemistry tests and for immunoassays.

According to some embodiments, kinetic energy of expelled drops is utilized for mixing thereby obviating the need for mechanical mixing elements.

For convenience, certain terms employed in the specification, examples, and appended claims are collected here.

As used herein, an “acoustic ejection device” includes an element (e.g., a piezoelectric element) for subjecting a chamber or cavity (referred to as an “ejection chamber”) holding a fluid to an acoustic wave, thereby ejecting or expelling the fluid from the chamber).

According to some embodiments, a “defined location” is defined within a certain tolerance, for example within 1 millimeters. The “distinct” defined locations are defined such that there is no mass transfer or substantially no mass transfer between these “distinct” defined location. In some embodiments, there is absolutely no mass transfer between reaction sites of the defined location so as not to compromise the individual locations or reaction sites.

The definition of a “sample collection device” is a receptacle or tube that is either partially open to the ambient environment, or a receptacle or tube that is closed with a “reversibly deployable” cap or cover. One example of a “sample collection device” is a capillary tube, such as, for example, the capillary tube 8 of FIG. 6

Two objects are “integrally formed” they are formed as a unitary solid object, as opposed to two objects which are mechanically attached to each other. According to some embodiments, said sample collection device is integrally formed with a conduit of said first acoustic ejection device.

As used herein, a “minute quantity of fluid” is between about 1 microliter and about 20 microliters of fluid. As used herein, a “nano quantity of fluid” is 20-100 nanoliters

As used herein, when two liquids “thoroughly mix” the liquids dissolve into each other.

As used herein, a “chemical reaction” involves one of breaking and/or forming of covalent bonds or immunochemical interaction in single or multiple steps, as opposed to van der Waals interactions or dissolving or dispersion which are physical interactions and not considered “chemical reactions.”

As used herein, when a first fluid containing element is “directly” above a second fluid containing element, there is no substantially no intervening element.

“Small quantities” are defined as less than 500 microliters; “minute” quantities are less than 20 microliters. In some embodiments, when a volume of a first container is “substantially smaller” than the volume of a second container, the ratio between the smaller and larger container is at most 0.2. The ejection chamber can expel small droplets of the fluid.

According to some embodiments, a coating of “hydrophobic material” is a material which allows formation of a drop of an aqueous liquid deposited on the coating.

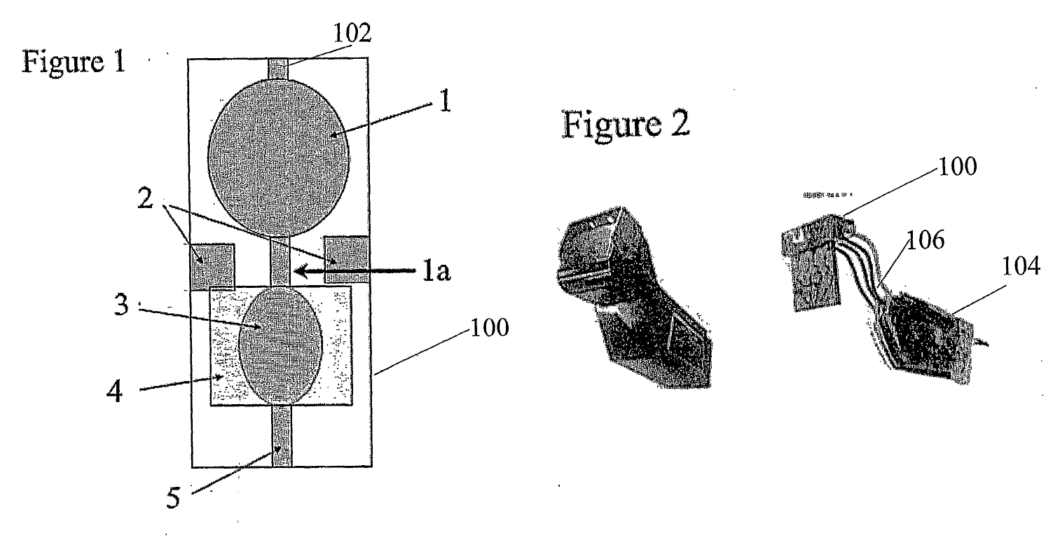

FIG. 1 provides an exemplary acoustic ejection device (100) adapted to operate as a two-way pump used typically for drawing and ejecting bodily fluids. As shown in FIG. 1, the device chambers is embedded in a wafer (e.g. a silicon wafer), e.g. processed by micro-machining and etching to form the chambers into the wafer. A thin glass plate bonded on the wafer. The device includes an ejection chamber (3). Thus, when the piezo actuators (4) coupled with (2) electrical connections introduces an acoustic wave into the ejection chamber (3), fluid residing in the ejection chamber is ejected through the outlet (5) or nozzle (e.g. one or more individual drops having a volume on the order of magnitude of 10 pico-liters are expelled) and thus expelled from the device.

Fluid can be introduced into the ejection chamber (3), for example, by flowing from the fluid reservoir (1) through an inlet conduit (1a).

Optionally, fluid is aspirated into the acoustic ejection device by flowing inwardly first through the outlet (5), then through the ejection chamber (3), then through the “inlet” conduit (1a) into the reservoir (1), which is optionally at least partially open to the ambient environment, for example, for providing ventilation.

In some embodiments, reservoir (1) is partially open to the external environment, for example, at location (102), to allow for ventilation.

According to some embodiments, the ejection chamber (3) has a volume between about 50 and about 100 nanoliters, has a characteristic length between about 2 and 3 mm, a characteristic width of between about ¼ mm and about 1 mm, and a characteristic depth of between about 50 and about 100 microns. It is noted that the above numbers describing dimensions and volume of the ejection chamber are provided for illustrative purposes only.

Typically, the acoustic ejection device includes an inlet conduit (1) for feeding fluid from an engaged sample collection device (e.g. a capillary tube (8) of FIG. 6) or from a reservoir (e.g. (1) of FIG. 1 or (6) of FIG. 4) into the ejection chamber. In some embodiments, the length of the inlet conduit is between about 50 microns and about 200 microns, the width of the inlet conduit is between about 20 and about 30 microns, and the volume is the inlet conduit is between about 2 and about 10 nanoliters. It is noted that the above numbers describing dimensions and volume of the inlet conduit are provided for illustrative purposes only.

Optionally, the inlet conduit is in fluid communication with a reservoir. In embodiments of FIG. 1, the reservoir is embedded in a wafer (e.g. a silicon wafer), and the reservoir volume is, for example, between about 5 microliters and about 40 microliters, with a length (e.g. along an axis parallel to the conduit) of, for example, between about 5-20 mm, and a width, for example, between about 5-10 millimeters and depth of 50-100 microns. It is noted that the above numbers describing dimensions and volume of the reservoir are provided for illustrative purposes only.

Typically, the device of FIG. 1 is used for dispensing a sample fluid onto a surface. In some examples, a separate acoustic ejection device is used for dispensing reagent to the same surface. FIG. 2 provides an image of an exemplary acoustic ejection device appropriate for dispensing a reagent.

It is noted that the cartridge (e.g. sealed cartridge 104) and the connecting tube (106) also function as a “reservoir” for holding reagent to be disposed. In some embodiments, the ratio between the volume of fluid held by the reagent reservoir (e.g. 104 and 106) (typically, on the order of magnitude of 5 milliliters) and the reservoir of the acoustic ejection device used for disposing sample (e.g. (1) of FIG. 1 or (6) of FIG. 4) (typically, on the order of magnitude of 200 microliters or less) is at least 25.

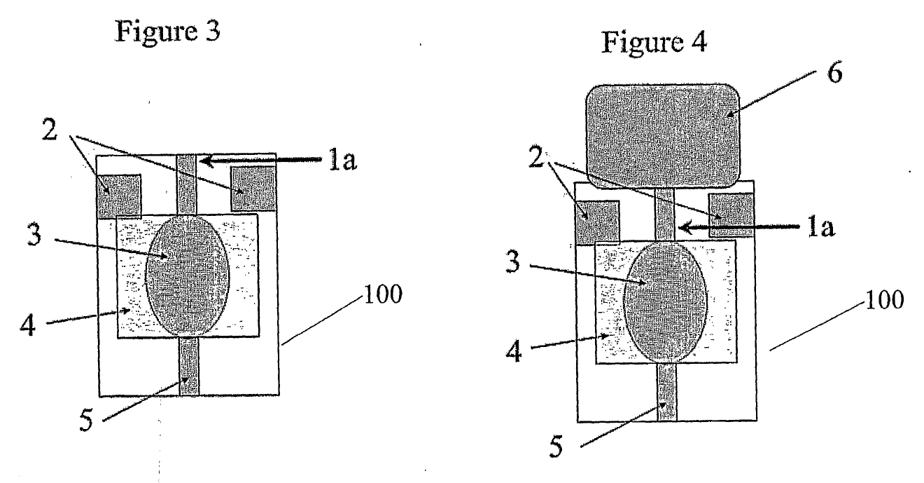

Although the acoustic ejection device having a dual-direction pumping mechanism for both aspirating and ejecting sample is appropriate for dispensing sample this is not a limitation, and unidirectional micro pumps (e.g. such as the pump of FIG. 3) are also appropriate for disposing sample according to some embodiments of the present invention.

FIG. 4 is an alternative embodiment of an acoustic ejection device of FIG. 1 coupled with a reservoir of a flexible bag (6) attached to the inlet conduit.

In embodiments of FIG. 4, the reservoir is, for example, a flexible sack and the reservoir volume is, for example, between about 20 micro-liters and 200 microliters, with a length (e.g. along an axis parallel to the conduit) of, for example, between about 1-2 mm, and a diameter, for example, between about 5-10 millimeters.

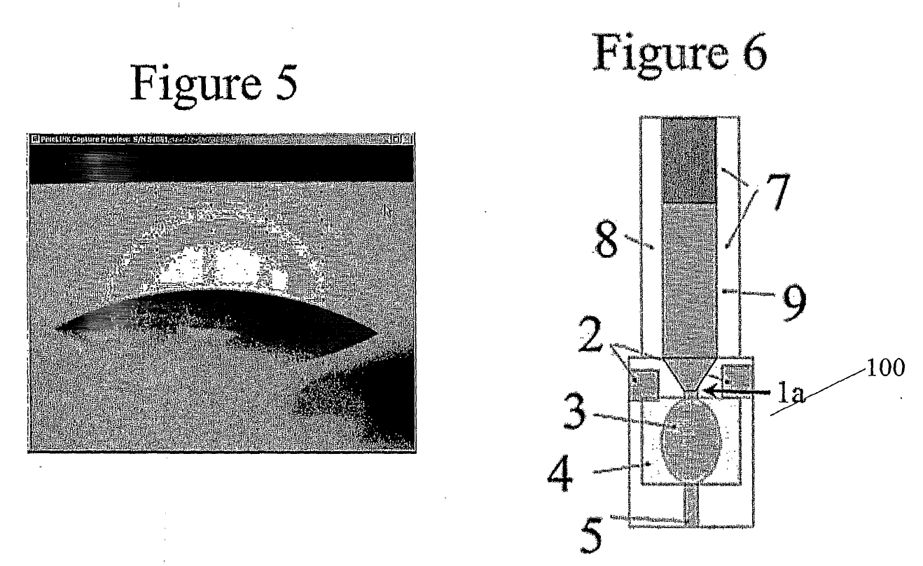

FIG. 5 is an in-process microphotograph demonstrating the mixing action created by ejecting dark fluid into a droplet of clear fluid. The process in FIG. 5 is one example of “thorough” mixing of two fluids. By dispensing two separate fluids (e.g. reagent and then sample) onto a surface using an acoustic ejection device, the need for a separate mechanical mixing process is obviated.

FIG. 6 is the system of an embodiment of the current invention wherein a capillary tube (8) mechanically attached to or integrally formed with to the inlet conduit and from there to the micro-pump. Optionally, the entire piece is then centrifuged to separate blood cells (7) and plasma or serum (9).

Optionally, the acoustic ejection device is pre-manufactured so that the capillary tube (8) is integrally formed with the conduit (1a) and the ejection chamber (3). The radius of the capillary tube is typically much greater (e.g. more than an order of magnitude) than the radius of the inlet conduit to which it is attached.

According to some embodiments, reagent and sample are both dispensed to a plate (e.g. a flat plate, or substantially flat plate) having a hydrophobic coating.

In some embodiments, the device is mechanically engaged to or integrally formed with a receptacle or tube, such as the capillary tube of FIG. 6.

Usage of the Aforementioned Devices

As depicted in the top part of FIG. 6, the ejector is connected to a capillary tube (8). This tube may be used to collect sample such as blood, either from a drop caused by finger prick, or from a vein puncture, or from a test tube filled with blood collected elsewhere, or from any other sample source.

In one non-limiting example, both ends of the capillary are open to allow free flow of liquid by capillary action. When the tip of the micro capillary is placed in a drop of biological fluid, it will be drawn inside its lumen by capillary force. Once the fused silica micro-capillary is filled (about 200 micro-liters), it is plugged at one end and placed in a small centrifuge, with the free end of the micro-capillary in the side proximal to the axis of centrifugation.

According to this example, during centrifugation the biological sample, plasma or serum is separated from the blood cells, and stays in close proximity to the ejector side as shown in FIG. 6.

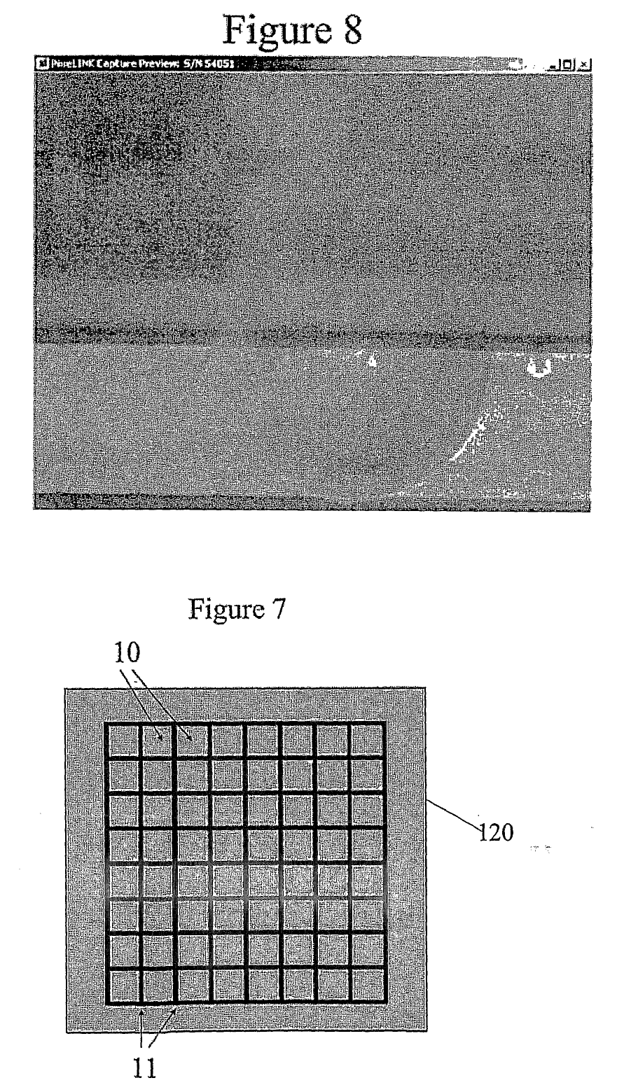

In some embodiments, droplets are ejected onto a reaction plate. Thus, FIG. 7 provides an image of an exemplary reaction plate (120) having hydrophobic properties. In the example of FIG. 7, the plate has a hydrophilic coating (10) and optional hydrophobic lines (11) according to some embodiments. In some embodiments, the reaction plate or subsections thereof are substantially flat.

In some embodiments, the reaction plate (120) is coated with a film of hydrophobic material (material that repels water) so that the spread of the ejected liquids will be confined to a small area.

In another example (not shown), the “plate having hydrophobic properties” has a hydrophobic coating.

In some embodiments, an embossed plastic disc (e.g. a plate) is provided, and then a hydrophobic layer is etched on the disk or plate, or ablated with an excimer laser

In some examples, both the samples and the reagents are aqueous water-based solutions or suspensions. Thus, in some embodiments, the drop retains its size and/or shape at the “reaction site” (where a chemical interaction or reaction occurs)

The formation of the droplet is useful for localizing and confining the deposited sample and/or reagent. In some embodiments, the hydrophobic material is useful for forming a droplet from and localizing a water-based solution, such as blood, serum, and cerebrospimal fluid. In one non-limiting example, the coating includes a silicon material.

Typically, a distance between the end of the outlet or nozzle (5) and the reaction plate is 1-5 millimeters

Optionally, after centrifuging and before dispensing sample, measures are taken to reduce a quantity of entrapped air (or a number and/or size of air bubbles) from the sample in the device. Thus, in one example, the ejector side of the device is placed into a tiny tube connected to a vacuum pump, and the serum is drawn into the cavity or ejection chamber (3) of the ejector to fill ejection chamber. According to this example, the air bubble elimination process is conducted under the guidance of an optical sensor (not shown in the figure) that stops the production of vacuum once the serum fills the ejector cavity completely. When this is accomplished, actuation of the piezo electric element within ejects pico-liter drops of sample to the reaction plate.

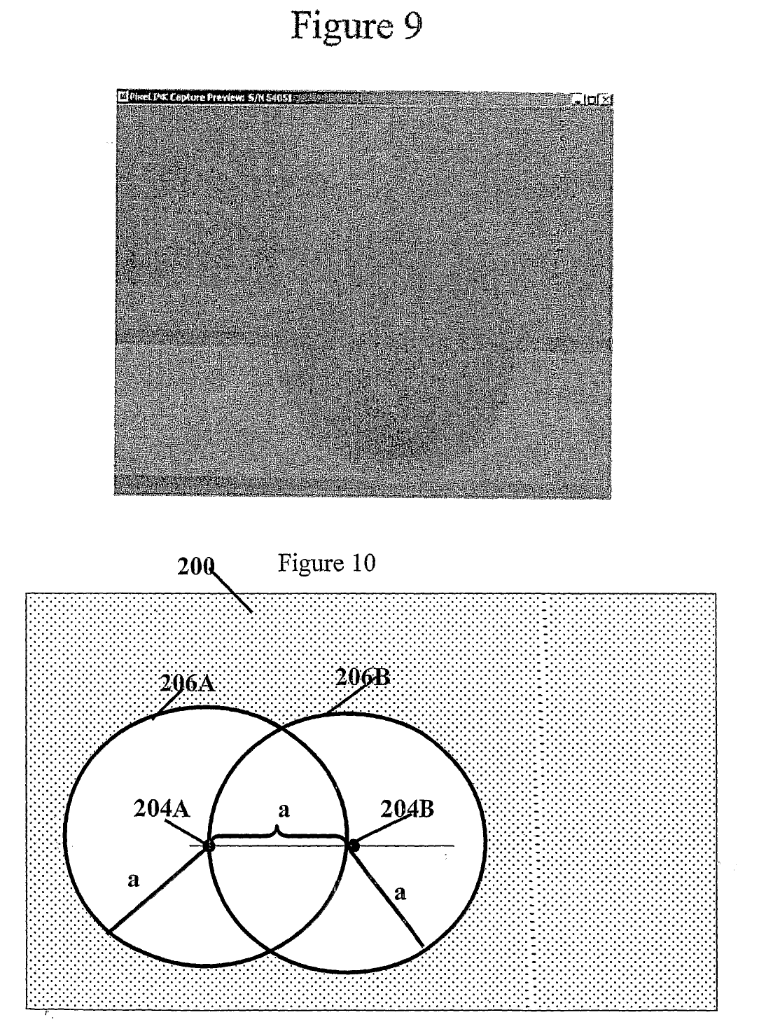

According to some embodiments, the acoustic ejector devices are used to dispense first reagent and then sample onto a surface. Thus, after dispensing reagent liquid onto the reaction plate, the sample is dispensed onto the plate and mixes with the reagent. FIGS. 8-9 depict images of this mixing process, where FIG. 8 represents an earlier time and FIG. 9 represents a later time. FIGS. 8-9 are from actual experiments performed by the present inventors.

As used herein, a “substantially flat area” is an area that is flat within a specific tolerance. Thus, in some embodiments, within a “substantially flat area” there are no intervening vertical features having a characteristic dimension greater than, for example, 1 centimeter, or preferably no greater than, for example 5 millimeters.

It is noted that a “local area” of two defined locations will be defined with reference to FIG. 10. The “local area” of two defined locations (e.g. 204A and 204B) separated by a distance α is the union of all positions whose distance to the center of at least one of the two defined location is less than the distance between the respective centers of the two defined locations (e.g. the union of the area within circle 206A and 206B). As used herein, a “local area” of more than two defined locations is defined as the union of the local areas of each pair of locations among the more than two defined locations.

In some embodiments, the acoustic ejection device for ejecting sample is disposed of after the completion of all testing on that sample, though this is not a limitation of the present invention. According to some embodiments, the reaction plate is also disposable, usually after all reaction locations on the plate have been utilized.

In some embodiments, reagent is dispensed by the nozzle into the prescribed location(s) in test fields. (This can be carried out multiple times from the same nozzle, as each nozzle will eject only one type of reagent.) Next, the sample is be ejected into the reagent droplet to mix with the droplet. In some embodiments, the location where the ejected droplet(s) reach the reaction plate is determined by a computer control. In some embodiments, reagent volume is significantly larger than the sample volume, and therefore the mixing process may be carried out with the sample injected into the reagent drop.

In one non-limiting example, the ejection velocity of the drops is about 6-10 meters/second, and the dispensing of the sample is carried out from a distance of about 1 mm, the fluids will be mixed by the physical energy involve. In one example, a 100 nano-liter volume may be spread on an area of about a square millimeter.

According to some embodiments of the invention, the reaction plate or disc IS flat with no intervening vertical feature, thereby allowing the nozzle (5) to move smoothly above the surface of the reaction plate (120).

In some embodiments, the sample and reagent are ejected in an enclosed chamber or housing where at least one of temperature and humidity is controlled, for example, by an environmental control device associated with a housing The housing can be metal or plastic or any other appropriate material. In one example, the environment control system is standard system to control air temp by heating or cooling by Paltie element, humidity is controlled by evaporation devices.

Not wishing to be bound by theory, it is disclosed that in some examples, the amount of reagents and biological sample is very small; thus, they can dry at different rates. There, in some examples, it is preferred to control the humidity, or to keep the ambient relative humidity at a reaction site (or location where droplets are deposited) at or near 100%.

In some embodiments, there is a chemical reaction between agents or compounds within the reagent and the sample, and a product of this reaction is analyzed or monitored, for example, by detection device (e.g. physical or chemical) which can, in some examples, determine a presence and/or a quantity of the product.

Exemplary detection devices include at least one of optical, acoustic, electrical, magnetic, and electrochemical detectors, though it is appreciated, that any detector is appropriate for the present invention.

Some embodiments of the present invention include a multi-channel analyzer (defined as multiple and simultaneous testing on a single biological sample and abbreviated as MCA) for performance of multiple chemical tests and immunoassays, with emphasis on biological samples. In one example, the system contains electronic, electromechanical, and optical elements that will meet one of more of the following requirements:
1. Use very small amounts of sample or reagents in comparison to conventional MCA systems.
2. Have fewer moving parts than conventional MCA.
3. Be small enough to be “desktop” type
4. Be able to rapidly process multiple simultaneous determinations
5. Be able to provide more accurate results due to parallel multiple determinations for each test (at a total volume substantially less than one determination on a conventional MCA) and statistical manipulation of the results.

Conventional MCA equipment requires several stages of cleaning, drying, and wiping of the dispensing devices. According to some embodiments, the present invention minimizes this equipment maintenance. Thus, in some examples, the micro-pumps used to dispense the biological sample are disposable and are used only on a single sample. Since the testing is done within seconds, the sample will not dry in the pumps.

In some embodiments, micro-pumps used to deliver the reagents require minimal maintenance, such as the infrequent purging in ink jet printing heads. The small reaction plates used as a support platform for the performance of the test are typically disposed of after all the testing locations on the plate are utilized. Thus, in some examples, there is a reduced need (or no need) for liquid waste disposal and its inherent safety problems. In these examples, containers used for the disposal of the sample injecting “heads” and the support platform plates are very small and are a part of the analytical system without any requirement for external infrastructure.

While the invention has been described with respect to a limited number of embodiments, it will be appreciated that many variations, modifications and other applications of the invention maybe made.

1-52. (canceled)

53. A system for analyzing biological fluids, comprising:
a. at least one first ejection device for holding and ejecting a reagent liquid that can associate with a specific compound in the biological fluid and generate a detectable reaction output upon association indicating at least one of a presence and a quantity of said specific compound, said ejection device having at least one piezoelectric actuator for ejection of drops of said reagent liquid onto a surface;
b. at least one second ejection device for holding and ejecting biological fluids obtained from a sample collection device, said ejection device having at least one piezoelectric actuator for ejection of drops of said biological fluid onto a surface; and
c. a reaction plate defining a plane in which each point can be defined by X-Y axes thereon, the plate being in association with the at least one first and the at least one second ejection devices such that the ejected fluid is dispensed onto an accurate X-Y position on the reaction plate forming a small droplet thereon.

54. A system according to claim 53 wherein said ejection device comprises:
a. a fluid reservoir chamber for holding the fluid;
b. an ejection chamber for holding and ejecting drops of the fluid;
c. an interconnecting conduit, for delivering the fluid from said reservoir to said ejection chamber;
d. an outlet nozzle linked to the ejection chamber for dispensing said droplets from the device; and
e. piezoelectric actuators associated with the ejection chamber and adapted to introduce an acoustic wave into the ejection chamber.

55. A system according to claim 54 wherein said two chambers are embedded in a wafer constructed of an inert material.

56. A system according to claim 55 wherein said inert material is glass or plastic.

57. A system according to claim 54 further comprising a covering layer for forming a seal with said wafer to close at least one of said embedded chamber, outlet and reservoir.

58. A system according to claim 54, wherein said fluid reservoir chamber is substantially tubular.

59. A system according to claim 58, wherein said fluid reservoir chamber is a capillary tube.

60. A system according to claim 59, wherein said capillary tube is used to collect biological fluid.

61. A system according to claim 58, wherein said ejection device is capable of being centrifuged in its entirety.

62. A system according to claim 60, wherein the biological fluid is blood and the device is capable of separating blood cells from plasma or serum.

63. A system according to claim 53 wherein said reaction plate has a pattern of alternating hydrophobic and hydrophilic coatings.

64. A system according to claim 52 wherein said reaction plate is an embossed plastic disk.

65. A device for carrying out a multiplicity of biochemical or immunological testing comprising a housing containing multiple ejection devices according to any of the preceding claims, wherein the biological fluid and the reagent are dispensed to a plurality of distinct defined locations on said reaction plate.

66. A method of laboratory analysis of biological fluids comprising:
a. ejecting a reagent liquid that can associate with a specific compound in the biological fluid and generate a detectable reaction output upon association indicating at least one of a presence and a quantity of said specific compound to a defined location on a reaction plate;
b. ejecting a biological fluid sample to said defined location such that drops of said biological fluid thoroughly mix with said reagent liquid at said defined location; and
c. determining at least one of a presence and a quantity of a specific compound in said biological fluid sample by analyzing the reaction output at said defined location.

67. A method according to claim 66 further comprising centrifuging of the biological sample prior to ejection onto the reaction plate.

68. A system according to claim 53 wherein the ejection kinetic energy of said ejected drops is such so as to permit mixing of the ejected fluid with a drop of another liquid already formed on said reaction plate.

69. A method according to claim 66 wherein the ejection kinetic energy of said ejected drops is such so as to permit mixing of the ejected fluid with a drop of another liquid already formed on said reaction plate.

70. A system according to claim 68 wherein said drops have a volume in the picoliters range.

71. A method according to claim 69 wherein said drops have a volume in the picoliters range.
